(19) United States
(12) Patent Application Publication
(10) Pub. No.: US 2010/0321494 A1
(43) Pub. Date: Dec. 23, 2010

(54) COMPACT DOME CAMERA

(75) Inventors: Mark D. Peterson, Lake Oswego, OR (US); Jeff Gohman, Hillsboro, OR (US)

Correspondence Address: MARGER JOHNSON & MCCOLLOM, P.C., 210 SW MORRISON STREET, SUITE 400, PORTLAND, OR, 97204, US

(73) Assignee: Theia Technologies, LLC, Wilsonville, OR (US)

(21) Appl. No.: 12/819,085

(22) Filed: Jun. 18, 2010

Related U.S. Application Data
(60) Provisional application No. 61/218,396, filed on Jun. 18, 2009.

(51) Int. Cl. H04N 5/225; H04N 7/18

(52) U.S. Cl. 348/143; 348/340; 348/E07.085; 348/E05.024

(57) ABSTRACT

A compact video capture system is provided with a folded optical assembly to reduce a relative system size while providing improved lens performance. The folded lens and optical assembly allow for an improved lens resolution and zoom capability while not overly restricting an F number in a compact dome camera. These compact video systems may be implemented in CCTV dome cameras or digital security cameras to improve image recording while being small enough to be discretely mounted. In one instance, the optical assembly includes a first lens system with a light gathering entrance oriented in a first optical axis direction, an image sensor configured to detect light gathered by the lens system oriented in a second optical axis direction, and an optical folding element disposed along the optical path to redirect light along the optical path by changing a traveling direction of the light.

### RELATED APPLICATIONS

This application claims priority to U.S. Provisional Patent Application No. 61/218,396, filed Jun. 18, 2009, entitled MICRODOME CAMERA, the contents of which are hereby incorporated by reference.

### FIELD OF THE INVENTION

This disclosure relates generally to video capture systems and more particularly to compact video capture systems with folded optical assemblies.

### BACKGROUND

Video capture systems, such as closed circuit television (CCTV) dome cameras, are popular in the security market because they provide a record of activities occurring at a recorded location and because of their deterrent effect on potential wrongdoers. As these video capture systems have evolved from rudimentary analog video cameras with grainy recordings to more advanced digital systems, image quality and relative size of the video imaging equipment has become increasingly important. In many instances, the vertical dimension (overall thickness) of these systems is becoming more important with a desire to make them as thin as possible. A relatively thin vertical dimension allows them to be inconspicuously placed so as not to detract from the décor of the area that requires video surveillance.

Video capture systems generally use single linear optical path systems, which include a lens and image sensor, that are pointed toward a specified direction of view by rotation about a pivot point within a vertical plane. These systems can be angled from 0 degrees to 90 degrees and then rotated about a pivot axis normal to the plane of the mounting plane to allow video capture over an entire hemisphere or, with additional hardware, an entire sphere. In some cases a folded optical path has also been used. Folded optical paths also point toward an area of interest by rotation about a pivot axis normal to the plane defined by the longitudinal axes of the folded optical path.

To maintain a thin form factor, however, the longitudinal length of the optical path must be relatively short in length. This length limitation negatively affects the performance of the video capture system by reducing the length of the optical path available for the lens and by creating a size limitation on the image sensor. That is, the lens must be very compact in order to accommodate the optical path, which can limit the lens resolution, zoom capability, and may require a restricted F number. For high resolution image sensors of small size, the pixels are very small, decreasing the low light functionality of the system and increasing the potential for electronic noise in the image.

### BRIEF DESCRIPTION OF THE DRAWINGS

FIG. 1 is a longitudinal cross-sectional view of a conventional dome video capture system.

FIG. 2 is a front cross-sectional view of a video capture system according to embodiments of the invention.

FIG. 3 is a side cross-sectional view of a video capture system according to embodiments of the invention.

FIG. 4 is a bottom plan view of a video capture system according to embodiments of the invention.

FIG. 5 is a front cross-sectional view of another video capture system having a dual folded lens according to embodiments of the invention.

FIG. 6 is a perspective block diagram of a lens system for a video capture system having a non-planar dual folded lens according to embodiments of the invention.

FIG. 7 is a front cross-sectional view of another video capture system having translatable optics for zoom and focus according to embodiments of the invention.

FIG. 8 is a front cross-sectional view of another video capture system having a motorized lens adjustment mechanism according to embodiments of the invention.

### DETAILED DESCRIPTION

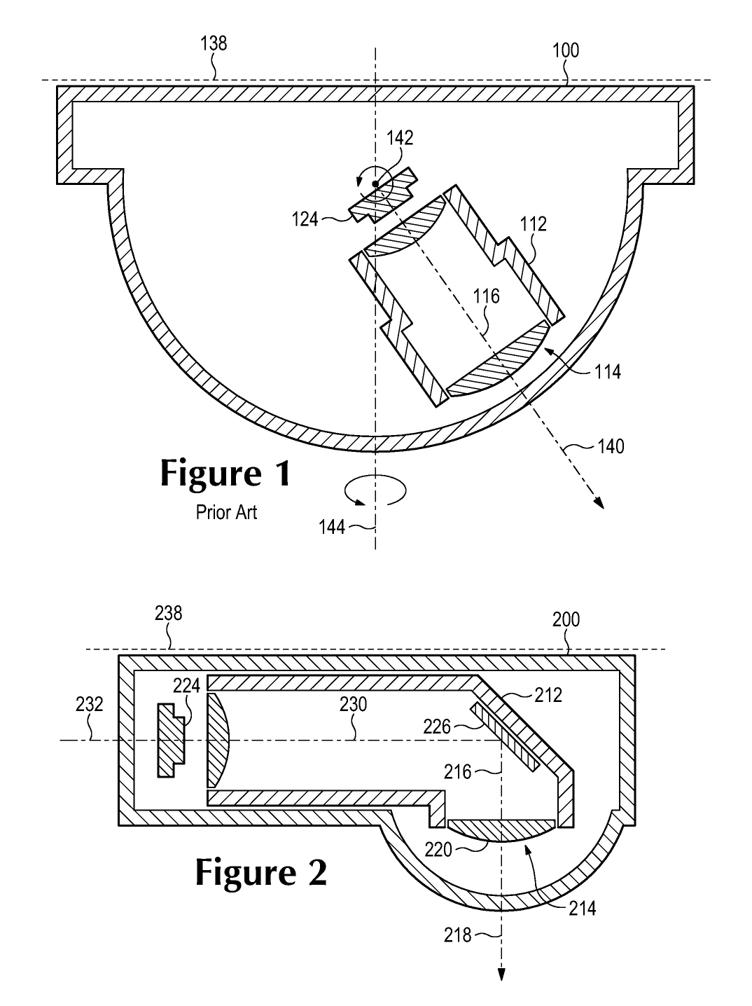

As discussed above, one issue with conventional video capture systems is that a reduction in size to the overall thickness of the image capturing hardware limits the longitudinal length of the optical path, which results in a reduction in the lens resolution and zoom capability while further requiring a restricted F number. FIG. 1 is a longitudinal cross-sectional view of a conventional dome video capture system. Referring to FIG. 1, in a conventional video capture system 100, the size of the dome enclosure constrains the size of the optical assembly lens 112. That is, as a result of reducing the overall vertical thickness of the video capture system 100 the length of the optical assembly lens 112 must be relatively short, which requires compromises in lens performance. The optical assembly 112 has an entrance 114 which collects light and directs is along an optical axis direction 116. Light travels through the optical assembly 112 and is transferred to the image sensor 124, which captures the image. In this conventional video capture system 100, the optical axis direction 116 is constant through the movement of the optical assembly 112.

In a typical security camera setup, the video capture system 100 will be mounted on a level ceiling with a mounting plane 138 parallel to the ceiling. The direction of view 140 of the optical assembly 112 can be changed by rotating the optical assembly about a first rotational axis 142 to change the vertical direction of view and about a second rotational axis 144 to change the horizontal direction of view.

As opposed to this conventional system that requires limited lens performance as a tradeoff for a relatively small size, embodiments of the present invention provide a video capture system with far superior lens performance while maintaining or even reducing the compact size of the system. Some embodiments of the present concept obtain these advantageous aspects by providing a folded lens and optical assembly for use in a compact video system. These compact video systems may be implemented in a CCTV dome camera or digital security camera dome, although, the scope of this invention is not limited to these two camera systems. It is understood that embodiments of the invention may have utility in military, video conferencing, projection, and many other devices requiring an imaging lens with a variable or settable field of view.

In one embodiment of the invention, a folded lens is used in a video capture system. The lens, which is part of an optical assembly that includes the image sensor, has an entrance to capture light from an object and direct the light along a direction. This direction is usually parallel to the optical axis of the initial part of the lens. At some point within the optical system, the light intersects an optical fold element such as a mirror or prism and is redirected along a second direction. This second direction is usually approximately 90 degrees from the initial direction but could be configured at any other angle change. In an embodiment with only one fold element, this second direction is parallel to the optical axis of the final part of the lens and is generally perpendicular to the plane of the image sensor. After travelling along this new direction, the image is captured at an image sensor.

The optical fold in the system allows many advantages over video systems without this feature. The folded lens allows the video capture system to be compact without limiting the performance of the lens. This allows the dome of the video capture system to remain relatively thin and compact with a protective dome having a diameter on the order of, for example, 1 inch to 2 inches without limiting the lens length. The folded lens in this compact dome may still have longitudinal length of, for example, 40 mm to 120 mm or more.

The relatively long length of the lens allows the use of many different optical lens elements within the optical assembly. Each of these optical elements performs a small change to the direction of the light transmitting through the surfaces of the element. In total, the elements create a focused image of the object at the image sensor. Keeping the directional change of the light at each individual element small and the number of elements large allows a greater degree of control of the light at different field points in the pupil and image. This greater control allows the lens to be designed without unwanted aberrations such as coma, astigmatism, and chromatic aberration, all of which increase the blur spot size at the image sensor. This smaller blur spot achievable with the larger number of lens elements means that the lens has a high image resolution and can focus light from points of the object onto a small spot at the image sensor. This allows the image sensor to have very small pixels and thus a large number of pixels in a small area. The large number of optical elements required to minimize the optical aberrations requires a certain physical distance between the lens entrance and image sensor. By folding the optical assembly, length of the lens can be increased without sacrificing video capture system compactness and while maintaining a small protective dome diameter.

The folded optical assembly also allows the use of larger image sensors. This folded optical assembly can use image sensors of, for example, ⅓″ format, ½″ format, 1/1.8″ format, or larger, as well as smaller image sensors. There are at least two advantages for using a large sensor: The first advantage is the ability to use a large number of pixels on the image sensor creating a very high resolution image; The second advantage is the ability to use large pixels which collect light more efficiently with a better signal to noise ratio creating an image which is more clear. Large image sensors generally require large diameter lens optics, which in turn requires a relatively long lens length. As discussed above, folding the optical assembly as set out in embodiments of this invention allows the length of the lens to be relatively long without requiring an overly large protective dome for the video capture system. For example, some of the folded optical assembly embodiments discussed herein can provided a lens length at twice that of a conventional video capture system while retaining relatively small diameters, such as 1 inch to 2 inch diameters.

The folded optical assembly can have one or more moving lens groups or systems allowing focal adjustment for different object distances and lens focal length adjustments for different angles of view. These moving lens groups are translated along their own optical axis and thus require physical air space around the lens group to move within. Folding the optical assembly allows additional room for adding translatable lens groups without the need for a larger protective dome cover or increased system thickness.

Furthermore, the direction of view of the camera can be pointed within an entire hemisphere or sphere by rotating the lens about the video capture system axis and one of the optical axis directions. Rotation about a pivot point within the plane defined by the longitudinal axes of the optical paths is therefore not needed. For instance, in an embodiment of a security camera mounted on a horizontal ceiling that includes a single fold in the optical system, the lens can be rotated about the second optical axis direction which is normal to the image plane. This has the effect of changing the direction of view of the camera in a vertical direction.

In addition to rotating about an axis in the optical assembly for vertical image pointing direction, the entire video capture system can be rotated about an axis perpendicular to the plane of the mounting bracket. This operation will change the direction of view of the camera in a horizontal direction. Here, the dome of the video capture system can remain small by allowing it to rotate along with the rest of the video capture system. The image on the monitor will appear to shift up or down and side to side as expected with the rotation of the optical assembly.

With rotating limits of 90 degrees about the optical assembly lens axis and 360 degrees about the video capture system axis, all directions in the hemisphere can be observed. Allowing a rotation of up to 180 degrees about the optical assembly lens axis and 360 degrees about the video capture system axis will allow all directions in a sphere to also be observed.

The folded optical assembly can include one or more motors to adjust optical performance aspects of the lens. The use of these one or more motors allows the video capture system user to adjust, for instance, the lens focus distance, lens focal length, angle of view, and/or direction of view, remotely or without physically touching the lens. This allows the video capture system to remain compact since there is no need to allow the video capture system user to remove the cover of the video capture system and there is no need to allow finger-sized access points to control these lens performance aspects. Advantageously, the one or more motors enable greater ease of use, as well as compactness, of the video capture system.

FIG. 2 is a front cross-sectional view of a video capture system according to embodiments of the invention. Referring to FIG. 2, a video capture system 200 is shown, which can be implemented in, for example, a CCTV security camera, digital network camera, or other image capture device. The video capture system 200 includes the folded optical assembly 212. The optical assembly 212 has an entrance 214 to capture light from an object and direct is along an initial optical axis direction 216. This optical axis direction is parallel to the normal 218 of the plane of the optical assembly entrance. Light travels through the lens impinging one or more lens optical elements 220 which, in combination with lens elements further along the optical path, serve to focus the light onto an image sensor 224.

Within the optical assembly, the direction of travel of the light is altered by an optical fold element 226, which in this embodiment is shown as an optical minor. In other embodiments, the fold element may also be a prism or other optical fold element. In this embodiment, only one fold element is shown in the optical path. However, in other embodiments two or more optical fold elements could be utilized along the optical path between the entrance and image sensor.

After received light is redirected by the fold element 226, it continues to travel through lens elements contained in the optical assembly along a second optical axis direction 230. This second optical axis direction 230 is parallel to the normal 232 to the plane of the image sensor and is substantially perpendicular to the initial optical axis direction 216. In other embodiments, the fold element 226 may fold the received light at an angle different than 90 degrees. In these embodiments, the second optical axis direction 230 may be angled from the initial optical axis direction 216 at an angle relative to the angle of the fold element 226. Here, the first optical axis direction 216 and second optical axis direction 230 intersect in the proximity of the optical fold element 226. In a typical security camera setup, the video capture system will be mounted on a level ceiling with a mounting plane 238 parallel to the ceiling.

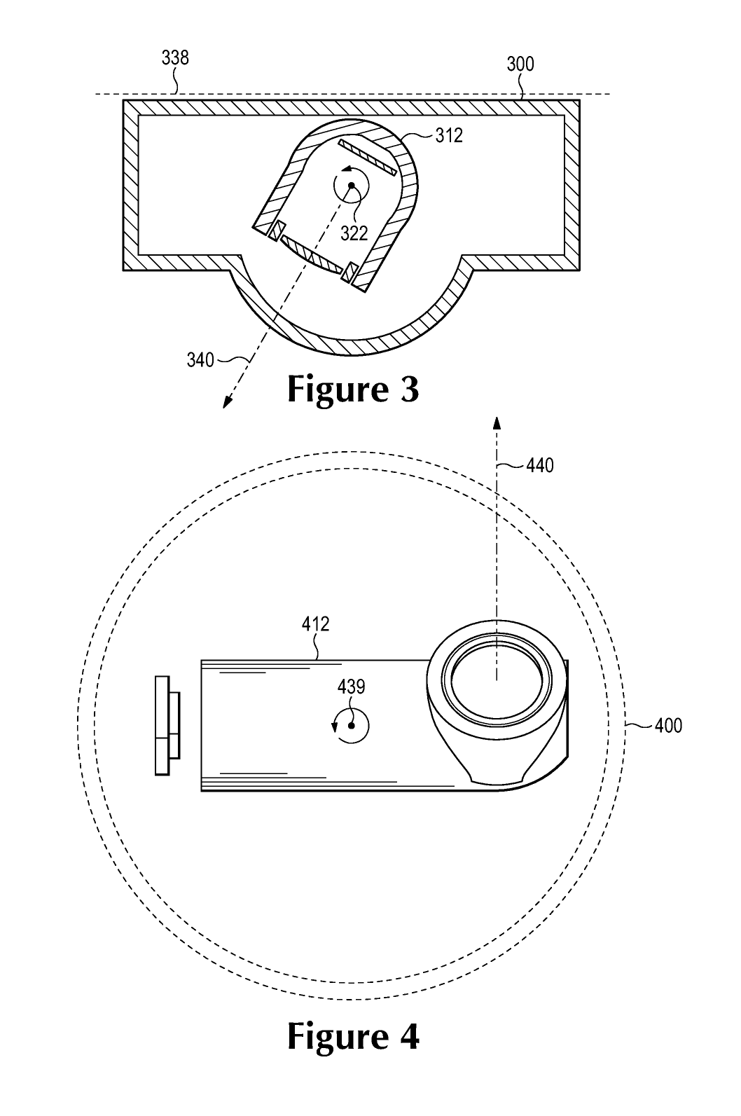

FIG. 3 is a side cross-sectional view of a video capture system according to embodiments of the invention. Referring to FIG. 3, the video capture system 300 includes an optical assembly 312 with a lens that can be rotated about a second optical axis direction 332 in order to change the direction of view 340 of the video capture system. In a typical security camera mounting configuration, this video capture system would be mounted on a level ceiling 338 with the lens pointing downward. In this embodiment, rotating the optical assembly 312 about this second optical axis direction 332 serves to vertically change the direction of view of the camera.

FIG. 4 is a bottom plan view of a video capture system according to embodiments of the invention. Referring to FIG. 4, a video capture system 400 includes a folded optical assembly 412 that may be rotated about a system axis 439 that is defined as substantially parallel to the mounting plane of the video capture system and serves to change the direction of view 440 of the video capture system. In other embodiments the entire video capture system 400 including the folded optical assembly 412 may be rotated about the system axis 439 to change the direction of view. In a typical security camera mounting configuration, where the video capture system is mounted on a level ceiling with the lens pointing downward, the rotation axis 439 is defined as parallel to the normal of the mounting plane 238 (FIG. 2).

Referring to FIGS. 3 and 4, if a rotation adjustment of 90 degrees about the second optical axis direction 332 and a rotation adjustment of 360 degrees about the system axis 439 are provided, a viewing direction can be obtained in any direction within the hemisphere. In another embodiment, a rotation adjustment of 180 degrees about the second optical axis direction 332 and at least 180 degrees about the system axis 439 will also allow a viewing direction to be obtained in any direction within the hemisphere. The adjustment ranges stated here are illustrative only and not are not intended to be limiting with regard to the invention.

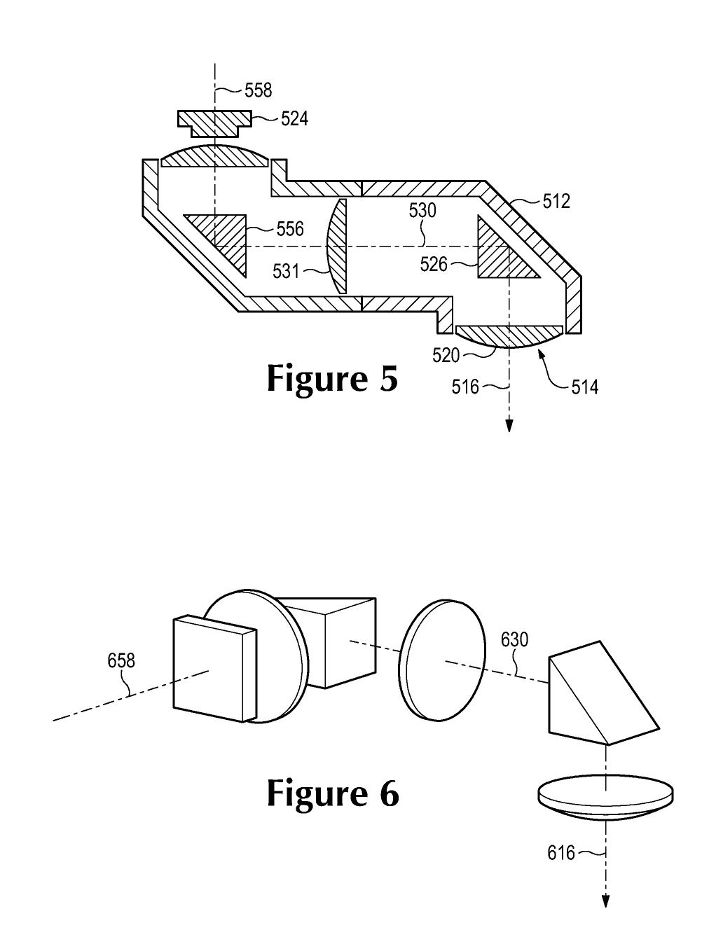

FIG. 5 is a front cross-sectional view of another video capture system having a dual folded lens according to embodiments of the invention. Referring to FIG. 5, an optical assembly 512 includes two optical fold elements 526, 556, which are used to fold received light twice before being detected by an image sensor 524. Here, light enters the optical assembly through an entrance 514 and is directed along a first optical axis direction 516. The light will be transmitted through optical elements 520 of the optical assembly where it intersects a first optical fold element 526. In this embodiment, the optical fold element shown is a prism, but may include various other optical fold elements in other embodiments.

This first optical fold element 526 serves to redirect the light from a first optical axis direction 516 to a second optical axis direction 530, which is different from the first optical direction. The change in direction of the light can be between approximately 60 degrees and 120 degrees, although other fold directions are possible. A typical change of direction will be about 90 degrees. The intersection of the first optical axis direction 516 and second optical axis direction 530 is in the proximity of the first optical fold element 526.

The light will be then be transmitted through one or more additional optical lens elements 531 in the optical assembly 512 along the second optical axis direction 530. The light traveling along the second optical axis direction will next intersect a second optical fold element 556, which will serve to redirect the light along a third optical axis direction 558. The intersection of the second optical axis direction 530 and third optical axis direction 558 is in the proximity of the second optical fold element 556. Again the change of direction of the light due to the second optical fold element 556 can be between approximately 60 degrees and 120 degrees, although other fold directions are possible. A typical change of direction will be about 90 degrees.

The first optical axis direction 516 and second optical axis direction 530 form a first plane. Likewise the second optical axis direction 530 and the third optical axis direction 558 form a second plane. The first plane and second plane are shown as coincident planes in the embodiment illustrated in FIG. 5. However, in other embodiments, the first and second planes may not be coincident or parallel, such as shown in the embodiment illustrated in FIG. 6. FIG. 6 is a perspective block diagram of a lens system for a video capture system having a non-planar dual folded lens according to embodiments of the invention. Referring to FIG. 6, a first plane is perpendicular to a second plane. That is, the first optical axis direction 616 and second optical axis direction 630 that form the first plane is perpendicular to the second plane that is formed by the second optical axis direction 630 and the third optical axis direction 658. In other embodiments, the first and second planes may be formed at various other angles relative to each other.

The embodiments shown in FIGS. 5 and 6 have the advantage of increasing the length of the lens further which allows for greater optical imaging performance, zoom range, and other advantages previously mentioned. That is, by using multiple optical fold elements, the effective lens length may be increased while maintaining a relatively compact video capturing system.

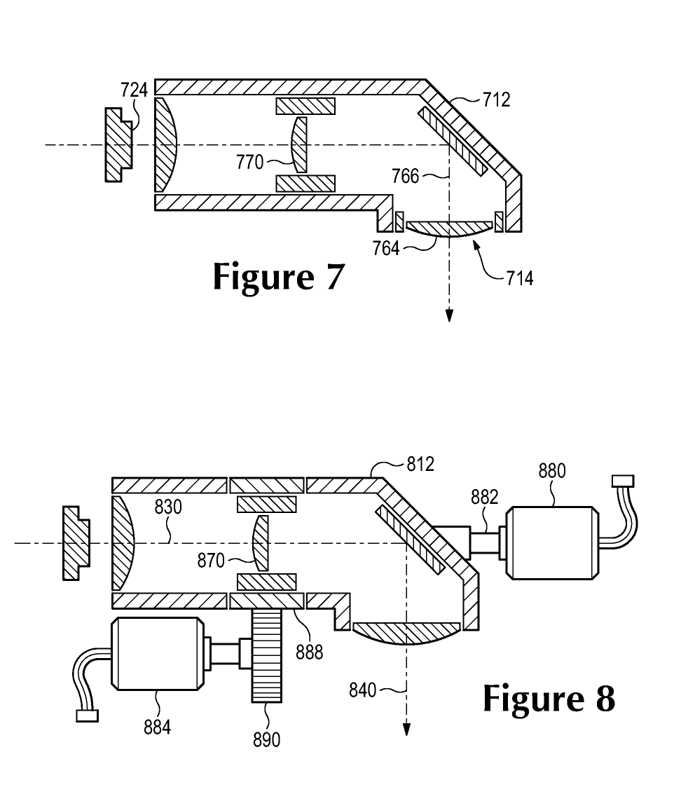

FIG. 7 is a front cross-sectional view of another video capture system having translatable optics for zoom and focus according to embodiments of the invention. Referring to FIG. 7, an optical assembly 712 is configured to transfer light from an entrance 714 to an image sensor 724, where an image is formed. The optical assembly 712 shown in the embodiment illustrated in FIG. 7 has three lens groups. A first translatable lens group 764 can be shifted along its optical axis direction 766 to change the focal distance of the optical assembly 712. This will allow the image detected by the image sensor 724 to have a sharp focus for objects that are relatively close to the lens entrance 714 or providing a sharp focus for objects that are relatively far from the lens entrance. A second translatable lens group 770 may be shifted along its optical axis direction to affect the magnification of the optical assembly. This allows a greater or lesser angle of view for the video capture system. The third lens group may include a final refining lens prior to the light reaching the image sensor 724. Although three lens groups are shown in FIG. 7, more or less lens group may be used in other embodiments. For example, the optical assembly 712 may have as few as one group or more than three groups. Additionally, the position and relative relationship of the lens groups shown is illustrative and is not intended to be limiting. For example, light could travel through a magnifying lens group prior to a focusing lens group or through a fixed lens group prior to a moving lens group.

FIG. 8 is a front cross-sectional view of another video capture system having a motorized lens adjustment mechanism according to embodiments of the invention. Referring to FIG. 8, a video capture system includes one or more motors that adjust performance characteristics of the folded optical assembly. In this embodiment, the optical assembly 812 has an optical axis direction 830 about which the optical assembly can be rotated to effect a change in direction of view 840. This rotation is accomplished by an electric motor 880 attached to the folded optical assembly. The shaft 882 of the motor 880 is coincident with the optical axis direction 830 of the folded optical assembly. Rotation of this shaft may be completed by means of applying electrical current to the motor by a motor controller (not shown) that will cause the entire folded optical assembly to rotate about an axis 830 and change the direction of view.

In addition, a second motor 884 may be attached to the folded optical assembly 812 in such a way as to cause one of the internal translatable lens groups 870 to be translated along its translation axis. In this illustrated embodiments, this translation is carried out by the rotation of cam 888 connected to a gear 890, which is attached to and driven by a second motor 884. In other embodiments, however, this translation can be accomplished by many different means. These one or more motors 884 that move the translatable lens groups can change the focal distance and/or magnification of the optical assembly.

The motor 880 to rotate the entire folded optical assembly 812 is shown with a shaft axis that is coincident with the optical assembly direction axis 830. However, this is not a requirement or limitation of the invention, as the shaft 882 of the motor 880 may be offset but parallel to the optical axis direction 830.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. An optical assembly for a video monitoring system comprising:
a first lens system with a light gathering entrance, the first lens system oriented in a first optical axis direction;
an image sensor configured to detect light gathered by the first lens system, the image sensor oriented in a second optical axis direction, wherein a distance traveled by the light from the first lens system to the image sensor defines an optical path; and
a first optical folding element disposed along the optical path, the first optical folding element configured to redirect light along the optical path by changing a traveling direction of the light,
wherein the optical assembly is configured to rotate about a first rotation axis parallel with one of the first or second optical axis directions.

2. The optical assembly of claim 1, further comprising a second lens system disposed along the optical path, wherein at least one of the first lens system and the second lens system is configured to be translatable along the optical path.

3. The optical assembly of claim 2, wherein at least one of the first lens system and the second lens system is configured to change the magnification of the optical assembly.

4. The optical assembly of claim 2, wherein at least one of the first lens system and the second lens system is configured to change the focal distance of the optical assembly.

5. The optical assembly of claim 2, further comprising an electric motor configured to control the translation of at least one of the first lens system and the second lens system.

6. The optical assembly of claim 1, wherein the first optical folding element is a minor.

7. The optical assembly of claim 1, wherein the first optical folding element is a prism.

8. The optical assembly of claim 1, wherein optical assembly has an F number between about F/1 and about F/5.

9. The optical assembly of claim 1, wherein the image sensor has an active area diagonal size between about 3 mm and about 25 mm.

10. The optical assembly of claim 1, further comprising an electric motor configured to control rotation of the optical assembly about a third optical axis direction substantially perpendicular to the first optical axis direction.

11. The optical assembly of claim 1, further comprising an electric motor configured to control rotation of the optical assembly about a third optical axis direction substantially parallel to the first optical axis direction.

12. The optical assembly of claim 1, wherein the first optical axis direction is substantially perpendicular to the second optical axis direction.

13. The optical assembly of claim 1, further comprising a second optical folding element disposed along the optical path, the second optical folding element configured to redirect light along the optical path by changing a traveling direction of the light.

14. The optical assembly of claim 13, wherein the first optical folding element is configured to redirect light from the first optical axis direction to a third optical axis direction, and wherein the second optical folding element is configured to redirect light from the third optical axis direction to the second optical axis direction.

15. The optical assembly of claim 14, wherein the first optical axis direction and the third optical axis direction define a first plane, and wherein the second optical axis direction and the third optical axis direction define a second plane.

16. The optical assembly of claim 15, wherein the first plane and the second plane are substantially coplanar.

17. The optical assembly of claim 15, wherein the first plane and the second plane are substantially perpendicular to each other.

18. A method for capturing an image in an optical assembly of a video monitoring system, the method comprising:
rotating the optical assembly about a rotation axis to change a field of view;
receiving light at a first lens system with a light gathering entrance, the first lens system oriented in a first optical axis direction;
redirecting the received light from the first optical axis direction to a second optical axis direction with a first optical folding element; and
detecting the redirected light at an image sensor,
wherein the rotation axis is parallel to the first or second optical axis direction.

19. The method of claim 18, further comprising redirecting the received light from the second optical axis direction to a third optical axis direction with a second optical folding element.

20. The method of claim 18, further comprising translating at least one of the first lens system or a second lens system to change the magnification of the captured image.

21. The method of claim 18, further comprising translating at least one of the first lens system or a second lens system to change the focus of the captured image.
